(19) United States
(12) Patent Application Publication
(10) Pub. No.: US 2005/0097521 A1
(43) Pub. Date: May 5, 2005

(54) System and method for migrating legacy applications to new software product architectures

(76) Inventor: Wei-Hsing Liu, Hsinchu City (TW)

Correspondence Address: DUANE MORRIS, LLP;IP DEPARTMENT, ONE LIBERTY PLACE, PHILADELPHIA, PA, 19103-7396, US

(21) Appl. No.: 10/696,301

(22) Filed: Oct. 29, 2003

(51) Int. Cl. G06F 9/44; G06F 9/45

(52) U.S. Cl. 717/136; 717/167

(57) ABSTRACT

A method and system is disclosed for migrating software applications from message bus environment to an object based environment. The first software environment uses a universal application invoking interface to call one or more applications and the second software environment requires each application to have an independent application invoking interface. This disclosure provides a model to simulate the message bus architecture within an object-based architecture by utilizing an Interface Definition Language (IDL) interface. This IDL interface simulates the message channel by using a send/reply interface module and an event module.

### BACKGROUND OF INVENTION

The present disclosure is generally directed to software systems, and, more particularly, to a system and method for migrating legacy applications to new software product architectures.

The following terms when used in relation to computer code or computer functions shall have the meanings provided: (1) “Application” refers to a single set of software functions that support a specific requirement. For example, in computer integrated manufacturing, production equipment maintenance (PEM) can be supported by a PEM application; (2) “System” refers to a collection of applications that support an overall business. For example, in computer integrated manufacturing, the overall manufacturing business can be supported by a manufacturing execution system (MES); (3) “Platform” refers to sections of the foundation for the overall system. For example, Windows NT is a platform.

The migration of legacy software applications is an economic imperative in the modern manufacturing environment. For example, semiconductor manufacturers must find ways to extend the life of their existing fabrication facilities despite limitations on existing computer integrated manufacturing (CIM) systems. Specifically, such legacy systems cannot support state-of-the-art process control technology. Existing systems have been in place for many years and have evolved into their present condition. With the creation of object technology, frameworks, and other system developments, new CIM products are now capable of handling the latest process technology through the use of “plug-and-play” modules. Current CIM products also have the ability to implement business practice changes rapidly and without massive programming efforts.

Unfortunately, the migration of legacy software applications (e.g., pre-existing applications performed by a predecessor software system) to new architectures is difficult and expensive. Each legacy application is typically intertwined with other applications to such an extent that migrating any one section of a system would have a negative impact on many other sections of the system. The only available approach has been the migration of the entire legacy platform. This approach is more likely to be cost prohibitive, however, given the substantial resources required to re-code the functionality of the legacy platforms, then test and debug the newly coded software in the new CIM environment.

The difficulties attendant with the conventional approaches to migrate legacy software applications to new architectures show that a need exists for an improved migration method.

### SUMMARY

In view of the foregoing, this disclosure provides a system and method for overcoming the difficulties of the prior conventional migration solutions. Specifically, this disclosure provides a system and method for migrating software applications from a message bus environment to an object based environment, the first software environment using a universal application invoking interface to call one or more applications and the second software environment requiring each application to have an independent application invoking interface. This disclosure provides a model to simulate the message bus architecture within an object-based architecture by utilizing an Interface Definition Language (IDL) interface. This IDL interface simulates the message channel by using a send/reply interface module and an event module.

These and other aspects and advantages will become apparent from the following detailed description, taken in conjunction with the accompanying drawings, illustrating by way of example the principles of the disclosure.

### BRIEF DESCRIPTION OF THE DRAWINGS

FIG. 1 illustrates two different client/server implementations and the plan to migrate from one to the other.

FIG. 2 illustrates a pre-migration TIBCO RV environment.

FIG. 3 illustrates a post-migration CORBA environment.

FIG. 4 illustrates a flowchart of the transactions in the system.

FIG. 5 illustrates code logic according to an exemplary embodiment of the invention.

### DESCRIPTION

The present disclosure provides an improved system and method for migrating legacy applications to new product architectures while minimizing system disruption of the legacy environment during the installation of the new environment, thereby keeping normal business operations intact during the process. For example, the system and method would provide a method for safely migrating legacy applications with no disruption or shut down of ongoing manufacturing operations.

As will be demonstrated in one example below, the present disclosure provides a system and method for migrating from a first software environment to a second software environment, the first software environment using a message bus to call one or more applications and the second software environment requiring each application in the first software environment to pass application messages into the second software environment through a proxy, into which a universal application invoking interface is compiled. The first software environment may be TIBCO RV, a TIBCO Software Inc. software product, while the second software environment may be Common Object Request Broker Architecture (CORBA). More information about CORBA can be found in “The Common Object Request Broker: Architecture and Specification,” Rev. 2.0, Object Management Group, Inc. (July 1995), hereinafter known as CORBA 2.0.

The CORBA environment provides an environment in which objects are strictly defined according to its architecture and specification reference. Each CORBA data-type encapsulates legacy messages as strictly defined by a unique interface definition language (IDL) interface in an IDL file. An embodiment of this unique IDL interface is illustrated in the following code snippet:

interface ORBFRAMEWORK {

| | |
|---|---|
| typedef | sequence<char> ORBMSG; |

unsigned long ORB_InvokeMethod (

| | |
|---|---|
| in | ORBMSG orb_RqstMsg, |
| inout | ORBMSG orb_RepMsg |

);
oneway void ORB_InvokeEvent (

| | |
|---|---|
| in | ORBMSG orb_RqstMsg |

);

};

The interface includes two routines that are used within the CORBA environment to simulate message channel in the TIBCO RV environment. The first routine, ORB_InvokeMethod, is designed to simulate TIBCO RV's send/reply model, and the other function, ORB_InvokeEvent, is designed for TIBCO RV's event model. The return type of each of the methods is compatible with the official list of types allowed by the IDL definition under the CORBA environment. The type name of the CORBA objects created in this example is ORBFRAMEWORK, which is the interface name defined in the IDL file. In this environment, any client invoking an operation on the server must use this IDL interface to specify the operation.

In one example, a design provides a migration plan that reuses most of the application logic, both on the server and the client sides, thereby reducing migration cost. Also, a flow mechanism is created to simulate message channel in the first software environment, thereby solving various migration issues. It is understood that an application includes any business logic that is relevant to application invocation. The migration plan utilizing the aforesaid universal application invoking interface will be described below.

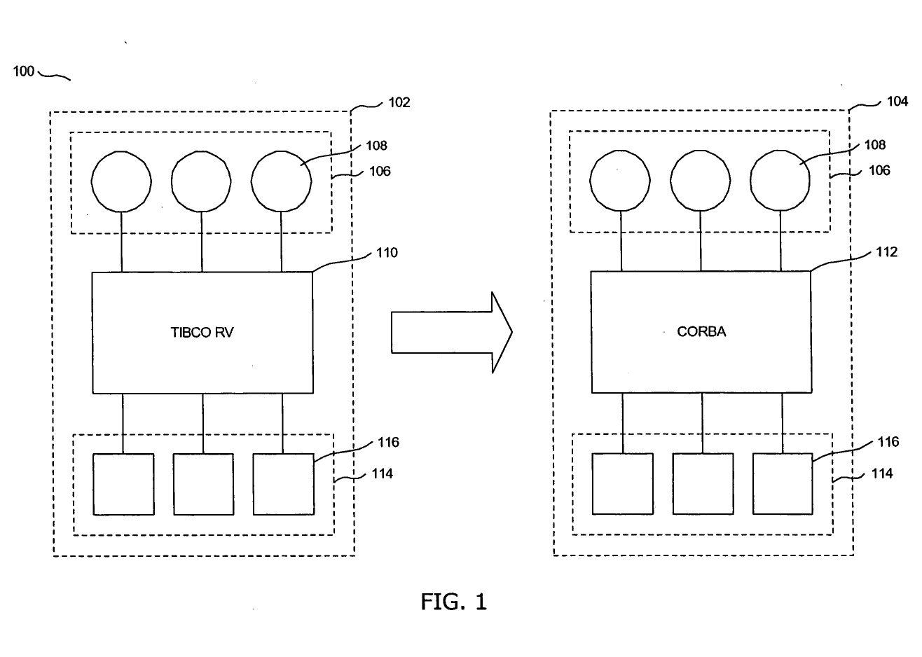

With reference to FIG. 1, two environments 102 and 104 show two different client/server implementations in two software environments, and the plan to migrate from one to another. In this example, environment 102 is the TIBCO RV environment, whereas environment 104 is the CORBA environment. Environment 102 includes a server group 106, which includes various servers 108, a TIBCO RV middleware architecture 110, and a client group 114, which includes various clients 116. Environment 104 includes a server group 106, which includes various servers 108, a CORBA middleware architecture 112, and a client group 114, which includes various clients 116. It can be seen in this migration method that the server and client group structures remain unchanged after the software environment change is complete.

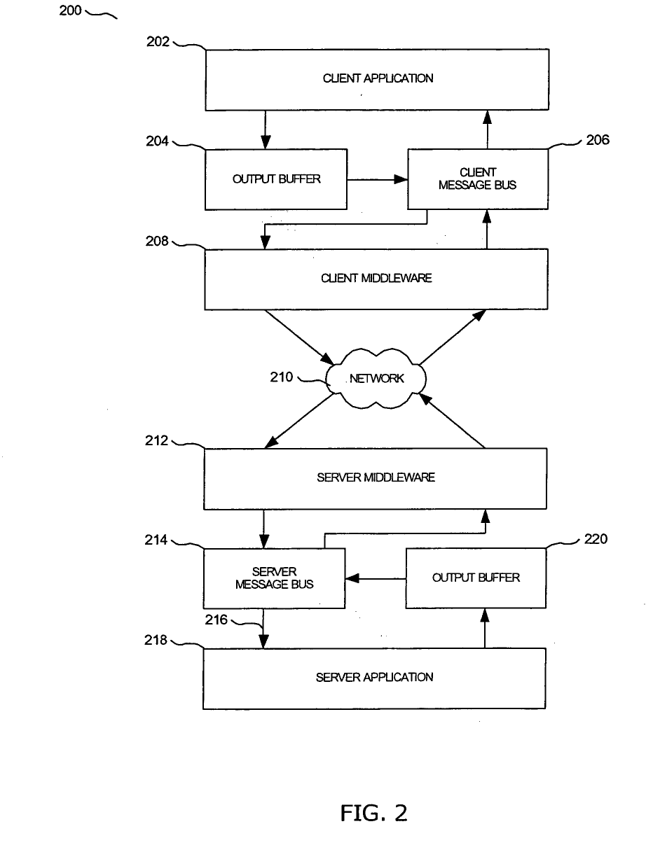

A sample pre-migration TIBCO RV environment 200 is illustrated in FIG. 2. In this environment, a client application 202 sends an application message to an output buffer 204, which passes the message to a client message bus 206, or the client subject. Client message bus 206 then passes the message to a client middleware 208, which locates the intended recipient of the message. The client middleware 208 then routes the message through a common network 210 to a server middleware 212, which is the intended recipient of the aforesaid message. Server middleware 212 then passes the message to a server message bus 214, which in turn passes the message through a path 216 to a server application 218, which accepts the message and produces the intended results accordingly.

The server application 218 returns a reply message by first sending the reply message to an output buffer 220, where the reply message is passed back to server message bus 214, which then passes the reply message back to server middleware 212. At this point, server middleware 212 locates the intended recipient of the reply message. The server middleware 212 routes the message through the common network 210 to the client middleware 208, which is the intended recipient of the reply message. The client middleware 208 passes the reply message to client message bus 206, which in turn passes the reply message back to client application 202.

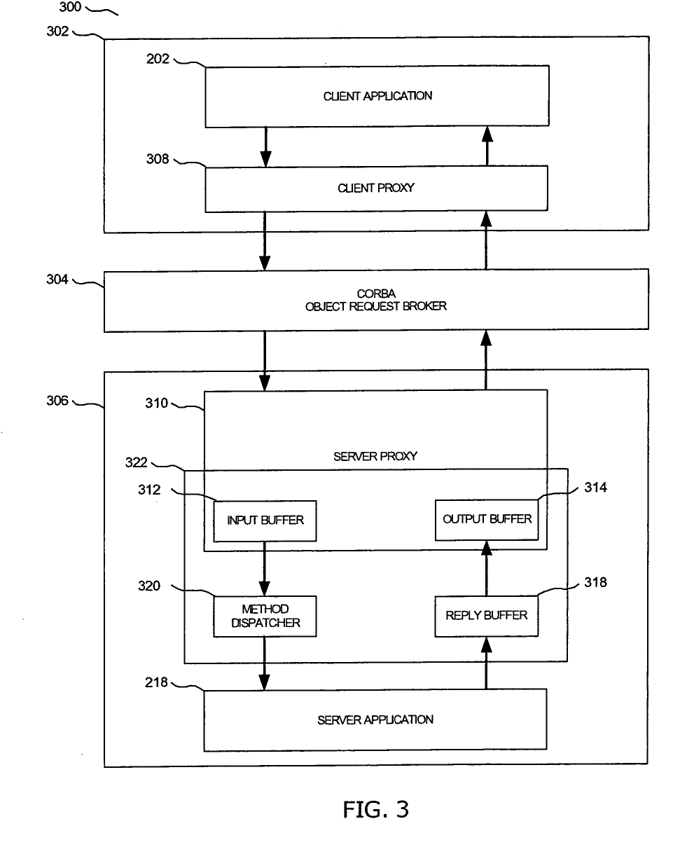

The migration process includes removing output buffer 204, client message bus 206, client middleware 208, server middleware 212, server message bus 214 and output buffer 220. What remains unchanged after moving to the new environment are client application 202 and server application 218. What is added to the post-migration CORBA environment 300 is illustrated in FIG. 3 according to one example of the present disclosure. This environment includes three logical parts: a client object 302, a CORBA Object Request Broker (ORB) 304, and a server object 306. Those skilled in the art will understand that a plurality of client objects and a plurality of server objects may be linked within a CORBA environment. Client application 202, the application logic that is wrapped within client object 302, sends an application message to a client proxy 308. In this example, the application message may be sent through a remote procedure call (RPC). Also in this example, wherein the post-migration software environment is the CORBA environment, client proxy 308, which serves as the client's proxy to the CORBA environment, is the IDL stub pursuant to CORBA 2.0. At this point, client proxy 308 marshals the TIBCO RV message into a CORBA data-type according to the IDL interface. Pursuant to CORBA 2.0, “marshaling” includes the encapsulation of an application message and its corresponding message arguments into a CORBA data-type, which may be a character string or a type struct. According to the IDL interface as defined earlier, the CORBA data-type in this example is a string of sequence characters. The term “unmarshal” hereinafter refers to the reversal of whatever is done by marshaling. Client proxy 308 also obtains the appropriate channel method for initializing a synchronized communication session with CORBA ORB 304 pursuant to CORBA 2.0.

Once a synchronized communication session is initialized and opened, CORBA ORB 304 locates the appropriate server object to receive the CORBA data-type. In this example, the recipient is a server object 306, which is connected to CORBA ORB 304 via a server proxy 310. In this example, wherein the post-migration software environment is the CORBA environment, server proxy 310, which serves as the server's proxy to the CORBA environment, is the IDL skeleton pursuant to CORBA 2.0. When the synchronized communication session is opened, two server buffers are created: an input buffer 312 for receiving CORBA data-types from, and an output buffer 314 for sending out CORBA data-types to, client object 302. The server proxy 310 also unmarshals the CORBA data-type according to the IDL interface. Server object 306 allocates a reply buffer 318, which is used to store and accumulate any reply message to be marshaled and sent back to client application 202. The unmarshaled message is then passed to a method dispatcher 320, which in turn passes the message to the intended server application 218. Those skilled in the art will understand that a plurality of server applications may exist within server object 306.

Reply buffer 318 receives and accumulates message data from server application 218 until the application routine is properly returned. An application routine refers to an operation routine in server application 218, while the return of the said routine refers to a successful completion thereof. After the application routine is properly returned, data in the reply buffer 318 is marshaled into a CORBA data-type, which is copied to the output buffer 314. In this example, the combination of input buffer 312, reply buffer 318, method dispatcher 320 and output buffer 314 constitutes a server framework 322. Finally, the CORBA data-type is sent, through CORBA ORB 304, back to client proxy 308, where the CORBA data-type is unmarshaled and the message contained therein returned to client application 202.

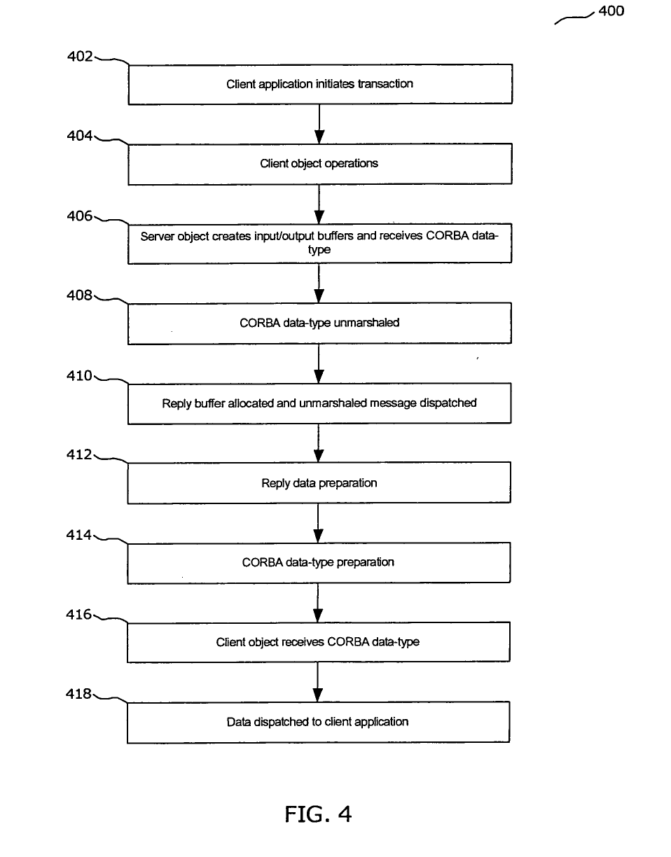

In FIG. 4, a flowchart 400 presents an action sequence that occurs in a system according to the above-described disclosure. In process box 402, client application 202 initiates a transaction. The transaction may be initiated by a user, equipment or a system event. Process box 404 represents the operations that take place in client object 302. Client application 202, which sits logically within client object 302, sends a message to client proxy 308, wherein: (1) the message is marshaled into a CORBA data-type; (2) an appropriate channel method for a session with CORBA ORB 304 middleware is selected and obtained; and (3) the CORBA data-type is sent to the selected server object 306. In process box 406, the server object 306 first creates input buffer 312 and output buffer 314, and then receives the CORBA data-type in input buffer 312. In process box 408, server proxy 310 unmarshals the CORBA data-type contained in input buffer 312. In process box 410, server object 306 allocates a reply buffer 318 and dispatches, through message dispatcher 320, the unmarshaled message to server application 218. In process box 412, the application routine in server application 218 processes the unmarshaled message and passes data to reply buffer 318. The contents in reply buffer 318 are transferred to output buffer 314 only when the application routine is properly returned and data marshaled. As represented by process box 414, when the application routine is properly returned, a CORBA data-type is created and placed in output buffer 314 by gathering and marshaling the message data in reply buffer 318. The resulting CORBA data-type is sent through CORBA ORB 304 to client proxy 308. Finally, client proxy 308 unmarshals the CORBA data-type in process box 416 and passes the data to client application 208 in process box 418.

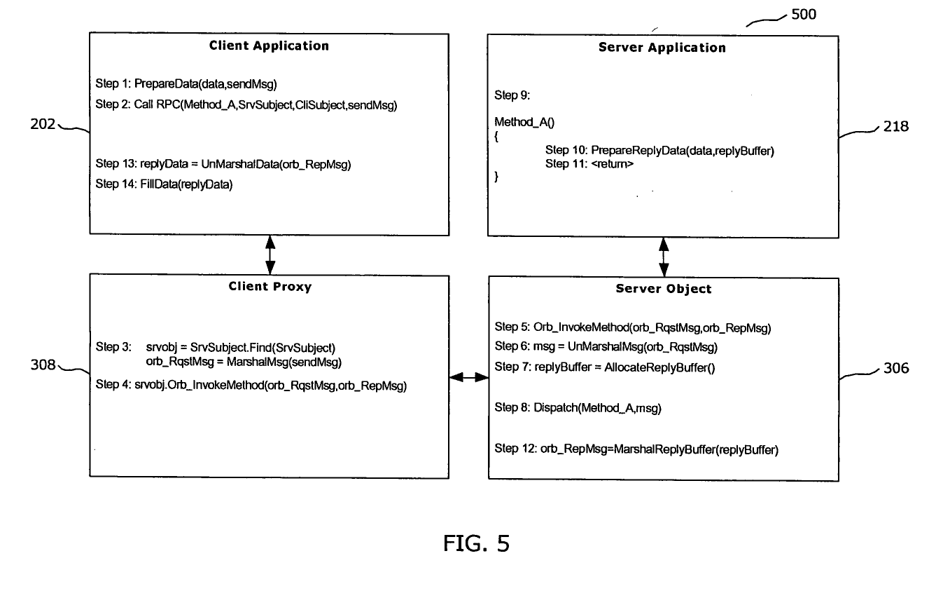

FIG. 5 illustrates a code logic 500 according to an exemplary embodiment of the invention. In step 1, as soon as a transaction is initiated in client application 202, the client application 202 prepares data using a routine PrepareData for the transaction. In step 2, an RPC sends sendMsg to client proxy 308. The RPC also sends the name of the client subject, CliSubject, the name of the server subject, SrvSubject, and the name of an application routine, Method_A. Method_A is the routine that the transaction needs to invoke. If the RPC is successful, client proxy 308 attempts to find the server object in step 3. The Find method returns srvobj, which may be an actual instance of, or an address location of an instance of server object 306. Also in step 3, client proxy 308 uses a routine MarshalMsg to marshal the message sendMsg. The routine MarshalMsg returns a CORBA data-type, which is passed, in step 4, to server object 306. After server object 306 receives the CORBA data-type in step 5, it unmarshals, using a routine UnMarshalMsg in step 6, the CORBA data-type into a TIBCO RV message msg. In step 7, a reply buffer replyBuffer is allocated using a routine AllocateReplyBuffer, which returns the allocated reply buffer. Those skilled in the art will understand that steps 6 and 7 may occur concurrently or asynchronously in two separate server threads.

After the CORBA data-type is unmarshaled, the unmarshaled message is dispatched, using a routine Dispatch in step 8, to server application 218. The routine may take in two arguments: the first of which points to the application routine and the second of which points to the TIBCO RV message. In step 9, server application 218 executes Method_A, which in turn includes steps 10 and 11. Step 10 prepares the data that will be returned to the client. Step 10 also puts the said data back in replyBuffer. After Method_A is successfully returned in step 11, a routine MarshalReplyBuffer is used to marshal the data contained in replyBuffer, the result of which is placed in the output buffer orb_RepMsg. The server object 306 then returns the CORBA data-type to client application 202. In step 13, the output buffer orb_RepMsg is unmarshaled, using a routine UnMarshalData, into TIBCO RV data replyData, which is eventually passed to the client application 202 through the routine FillData.

This novel method for environment migration leverages the preservation of the legacy software for maintaining functionality of legacy applications. The legacy software remains active during the CORBA environment installation as the interface to the legacy applications from clients in CORBA are structured to simulate the older message bus interface. Since the legacy software remains unchanged, the functioning of the legacy server is undisturbed by the installation of the CORBA environment. Hence, the operations and transactions within the manufacturing facility remain undisturbed throughout the environment migration. It will also be realized that this disclosure advantageously provides a real-time, non-disruptive method for validating CORBA transactions sent to legacy applications prior to releasing the new environment for general use. Specifically, initiating a transaction from a CORBA server and receiving the correct response from the legacy application validates each CORBA transaction.

The above disclosure provides many different embodiments, or examples, for implementing different features of the disclosure. Specific examples of components, and processes are described to help clarify the disclosure. These are, of course, merely examples and are not intended to limit the disclosure from that described in the claims.

Although illustrative embodiments of the disclosure have been shown and described, other modifications, changes, and substitutions are intended in the foregoing disclosure. Accordingly, it is appropriate that the appended claims be construed broadly and in a manner consistent with the scope of the disclosure, as set forth in the following claims.

1. A method invoking applications associated with a first software environment in a second software environment while migrating software applications from the first software environment to the second software environment, the method comprising:
initiating a request message for invoking an application by a client according to a message bus based architecture; and
utilizing an Interface Definition Language (IDL) interface based on the request message, the IDL interface using input and output buffers for information exchange conforming to the second software environment,
wherein the request message is passed through the input buffer to a predetermined server hosting the application and reply message data returned therefrom is passed through the output buffer.

2. The method of claim 1 wherein the utilizing further includes creating an input buffer for receiving one or more messages from the client and an output buffer for receiving the reply message data from the predetermined server.

3. The method of claim 1 wherein the utilizing further includes:
identifying the server hosting the application;
initiating a synchronized communication session with the identified server, the synchronized communication session passing the request message to the identified server;
processing the message by the identified server for invoking the application; and
returning reply message data associated with the invoked application from the server.

4. The method of claim 3 wherein the initiating a synchronized communication session further includes:
locating a server object to receive the request message;
placing the request message in the input buffer;
dispatching the message to the application; and
placing reply message data in the output buffer when the application responses.

5. The method of claim 4 wherein the placing reply message data further includes accumulating the reply message data in a reply buffer before copying same to the output buffer.

6. The method of claim 1 wherein the first software environment is TIBCO RV environment

7. The method of claim 1 wherein the second software environment is a synchronized communication session based environment.

8. The method of claim 7 wherein the second software environment is a COBRA environment.

9. A computer program for invoking applications associating with a TIBCO RV environment in a CORBA environment while migrating software applications from the TIBCO environment to the CORBA environment, the program comprising instructions for:
initiating a request message for invoking an application by a client according to a message bus based architecture; and
utilizing an Interface Definition Language (IDL) interface based on the request message, the IDL interface using an input and output buffers for information exchange conforming to the second software environment,
wherein the request message is passed through the input buffer to a predetermined server hosting the application and reply message data returned therefrom is passed through the output buffer.

10. The program of claim 9 wherein the instructions for utilizing further includes instructions for creating an input buffer for receiving one or more messages from the client and an output buffer for receiving the reply message data from the predetermined server.

11. The program of claim 9 wherein the instructions for utilizing further includes instructions for:
identifying the server hosting the application;
initiating a synchronized communication session with the identified server, the synchronized communication session passing the request message to the identified server;
processing the message by the identified server for invoking the application; and
returning reply message data associated with the invoked application from the server.

12. The program of claim 11 wherein the instructions for initiating a synchronized communication session further includes instructions for:
locating a server object to receive the request message;
placing the request message in the input buffer;
dispatching the message to the application; and
placing reply message data in the output buffer when the application responses.

13. The program of claim 12 wherein the instructions for placing reply message data further includes instructions for accumulating the reply message data in a reply buffer before copying same to the output buffer.

14. A method for invoking applications while migrating software applications from a first middleware software environment to a second middleware software environment, the method comprising:
initiating a request message for invoking an application by a client in the CORBA software environment;
sending the request message to an Interface Definition Language (IDL) interface;
marshaling the message into a message object;
establishing a communication session between the IDL interface and a CORBA middleware;
locating a server object to receive the message object;
creating input and output buffers for the established communication session;
placing the request message in the input buffer after extracting same from the message object;
passing the request message in the input buffer to the application hosted by a server;
processing the message by the application;
accumulating reply message data associated with the invoked application from the server to a reply buffer;
copying the reply message data from the reply buffer to the output buffer;
marshaling the reply message data in the output buffer by an IDL skeleton into one or more reply message objects;
sending the marshaled reply message objects to the IDL interface;
unmarshaling the reply message objects; and
conveying the unmarshaled reply message data to the client.

15. A method for operating applications while migrating software applications from a TIBCO software environment to a CORBA software environment, the method comprising:
receiving a request message from a client for operating an application, the request message conforming to TIBCO protocol;
marshaling the message into a message object through a universal application invoking Interface Definition Language (IDL) stub; conducting a communication session with a CORBA object request broker for locating a server object to identify the application for processing the message object;
receiving reply message data from the application; and
sending the reply message to the client.

16. The method of claim 15 wherein the conducting further includes creating input and output buffers;
placing the request message in the input buffer after extracting same from the message object;
processing the message by the application;
accumulating reply message data associated with the invoked application in a reply buffer; and
copying the reply message data from the reply buffer to the output buffer.

17. The method of claim 16 wherein the conducting further includes:
marshaling the reply message data into one or more reply message objects; and
sending the marshaled reply message objects from an IDL skeleton to the CORBA object request broker.

18. The method of claim 17 further includes:
unmarshaling the reply message objects by the IDL stub; and
conveying the unmarshaled reply message data to the client.
